(19) United States
(12) Patent Application Publication
(10) Pub. No.: US 2010/0107150 A1
(43) Pub. Date: Apr. 29, 2010

(54) TERMINAL HAVING APPLICATION UPDATE MANAGING FUNCTION, AND APPLICATION UPDATE MANAGING PROGRAM AND SYSTEM

(76) Inventors: Tomihisa Kamada, Tokyo (JP); Hiroyuki Suzuki, Yokohama (JP); Fumio Kawabata, Saitama (JP)

Correspondence Address: MORRISON & FOERSTER LLP, 425 MARKET STREET, SAN FRANCISCO, CA, 94105-2482, US

(21) Appl. No.: 12/532,125

(22) PCT Filed: Mar. 4, 2008
(86) PCT No.: PCT/JP2008/000441

§ 371 Date: Sep. 18, 2009

(30) Foreign Application Priority Data
Mar. 20, 2007 (JP) 2007-073565

(51) Int. Cl. G06F 9/44; G06F 3/048

(52) U.S. Cl. 717/170; 715/822

(57) ABSTRACT

A basic information recording unit 122 stores version data in which the versions of a plurality of application programs stored in a portable information device is written. An update verifying unit 110 receives update status data indicating whether an update to the version of at least one of the plurality of application programs is available. An update identifying unit 112 refers to the update status data and identifies an application program assigned an older version number in comparison with the updated version. A display processor 114 displays a menu screen where a plurality of startup icons for the plurality of application programs are located, and changes the appearance of the startup icon for the application program identified by the update identifying unit 112 to indicate that an update to the version is available.

### TECHNICAL FIELD

The present invention relates to a technology of managing the update of applications installed in an information terminal such as a cell phone.

### BACKGROUND ART

Information terminals such as personal computers and cell phones available recently have a variety of applications programs installed in the terminal. A large number of application programs are frequently updated to new versions for the purpose of adding new functions, fixing bugs, or implementing security measures. It would be increasingly difficult for users to thoroughly keep track of information on version updates as the number of application programs increases. Even if the user becomes aware of an update to the version, it would be troublesome to the user to access a designated website and download a new version of an application program each time an update occurs.

For example, patent document No. 1 discloses a system to address the above-mentioned disadvantage, wherein the client manages the frequency of use of necessary programs. The client issues an inquiry to the server to request version information on programs that are frequently used. When the versions do not match, the client automatically downloads the latest version. The document claims that this will improve system performance and make management activities more efficient.

[patent document No. 1] JP 10-240538

### DISCLOSURE OF THE INVENTION

### Problem to be Solved by the Invention

However, according to the patent document No. 1, the latest version of a program is automatically downloaded from the server. In the case that the client is a portable terminal, the user may not want downloading depending on the condition of communication or due to the communication cost that should be incurred. To help the user decide whether to download the latest version, it is desirable to make it easily recognizable whether the latest version of intra-terminal application programs is available.

The present invention addresses the above-mentioned challenge and a purpose there is to provide an application management technology capable of instantly identifying those of application programs installed in a terminal of which an update is available.

### Means to Solve the Problem

One embodiment of the present invention relates to a terminal provided with an application update management function. The terminal comprises: a version storage unit operative to store version data for a plurality of application programs stored in the terminal; an update verifying unit operative to receive, from a server managing the versions, update status data indicating whether an update to the version of at least one of the plurality of application programs is available; an update identifying unit operative to refer to the update status data and identify an application program assigned an older version number in comparison with the updated version; and a display processor operative to display a menu screen where a plurality of startup icons for the plurality of application programs are located, and to change the appearance of the startup icon for the application program identified by the update identifying unit to indicate that an update to the version is available.

According to the embodiment, the user can instantly identify those of the intra-terminal applications for which version update is available by changing the appearance of the startup icon for an application program in the menu screen to indicate that an update to the version is available. This is particularly useful for a portable terminal having the severely restricted user interface. In other words, the user viewing the screen is capable of knowing that the latest version is available and efficiently determining whether to update the application program, without having to start a plurality of application programs by using a button in the portable terminal and examine version information by switching the screen.

The display mode of “menu screen” is non-limiting so long as startup icons for a plurality of application programs are displayed and one of the icons can be selected. When the terminal provided with an application update management function is a cell phone, the menu screen may be a standby screen or a background screen where some of the startup icons are located. The main screen of a portal site viewed by a browser provided in the terminal may be the menu screen, if the main screen shows icons from which applications can be started.

The terminal may further comprise: a use frequency information recording unit operative to record use frequency of the plurality of application programs in the terminal. The display processor may change the appearance of the startup icon for the application program identified by the update identifying unit, depending on the use frequency. In this way, additional information other than the fact that an update to the version is available can be conveyed to the user depending on the use frequency of the application program.

The terminal may further comprise: a use frequency information recording unit operative to record use frequency of the plurality of application programs in the terminal. The display processor may change the appearance of the startup icon for the application program which is identified by the update identifying unit and which is used comparatively frequently in the terminal. This eliminates intrusiveness of the frequently changing appearance of the startup icon of the application program that the use does not normally use.

The display processor changes the appearance of the startup icon by adding a mark indicating that an update to the version is available.

When there is a non-updated application which has not been updated for a comparatively long period of time despite the fact that the user is notified of the update to the version, the display processor may change the appearance of the startup icon for the non-updated application program to an appearance different from the appearance indicating that there is an update to the version. This can prompt the user to update the non-updated application to the latest version.

The update verifying unit receives the update status data only for the application program used comparatively frequently in the terminal. Limiting the update status data received helps reduce the packet charge incurred for communication with the server. The feature will be particularly useful if the terminal is a cellular phone.

The update verifying unit further receives information related to the importance of the update to the version as update status data, and the display processor changes the appearance of the startup icon for the application program for which an update is available, depending on the importance of the update. This allows the user to instantly understand whether the update is important or a minor change in the menu screen.

Another embodiment of the present invention relates to a server-client system for managing the update of applications installed in a terminal. The update management server comprises: a version storage unit operative to store version data for a plurality of application programs stored in the terminal; an update verifying unit operative to receive, from a delivery server configured to deliver an application program, update status data indicating whether an update to the version of at least one of the plurality of application programs is available; and an update identifying unit operative to refer to the update status data and identify an application program assigned an older version number in comparison with the updated version, and to transmit identification information on the application program thus identified to the terminal. The terminal comprises: a receiver unit operative to receive identification information on an application program from the update management server; and a display processor operative to display a menu screen where a plurality of startup icons for the plurality of application programs are located, and to change the appearance of the startup icon for the application program corresponding to the identification information to indicate that an update to the version is available.

According to the embodiment, the update management server manages the version data for application programs. This allows the update management server to refer to the update status data to communicate with the terminal only when an update to the version of the application program is available. Therefore, the volume of communication is reduced.

Optional combinations of the aforementioned constituting elements, and implementations of the invention in the form of methods, apparatuses, systems, recording mediums and computer programs may also be practiced as additional modes of the present invention.

### ADVANTAGE OF THE PRESENT INVENTION

According to the invention, those of the application programs installed in a terminal, the version of which is updated, can be recognized easily.

### BRIEF DESCRIPTION OF THE DRAWINGS

FIG. 1 shows the overall configuration of a network system including a portable information device provided with an application update management function according to the embodiment;

FIG. 2 shows the hardware configuration of the portable information device;

FIG. 3 is a block diagram for explaining a relationship between an application program and an operating system in the portable information device;

FIG. 4 shows the configuration of those parts of the portable information device related to an application update management device according to the embodiment;

FIG. 5 shows a table including exemplary use frequency information generated by the use frequency information generating unit based on the record of activation status;

FIG. 6 shows a table that maps the score of use frequency, the frequency of acquiring update status data, and the change in the appearance of a startup icon to each other;

FIG. 7 shows a table including exemplary information related to intra-terminal applications and stored in a basic information recording unit and an update frequency recording unit;

FIGS. 8A and 8B schematically show how update status data is acquired;

FIG. 9 shows an exemplary menu screen displayed on a display screen of the portable information device;

FIG. 10 shows how a mark indicating an update to the version is attached to a startup icon.

FIG. 11 shows how another mark indicating an update to the version is attached to a startup icon;

FIG. 12 shows how information other than that of version update is acquired from a delivery server and displayed;

FIG. 13 shows an alternative mode of displaying additional information;

FIG. 14 shows how the latest version of an intra-terminal application, the startup icon of which has a NEW mark attached thereto, is installed;

FIG. 15 is a flowchart showing a process, according to the embodiment, of managing an update to an application; and

FIG. 16 shows an exemplary screen in which the user sets the timing and frequency of acquiring update status data.

### DESCRIPTION OF THE REFERENCE NUMERALS

10 portable information device, 102 file storage unit, 104 access processor, 106 activation status storage unit, 108 use frequency information generating unit, 110 update verifying unit, 112 update identifying unit, 114 display processor, 116 application addition unit, 118 user instruction acknowledging unit, 120 application information storage unit, 122 basic information recording unit, 124 update frequency recording unit, 126 use frequency recording unit

### BEST MODE FOR CARRYING OUT THE INVENTION

One embodiment of the present invention relates to an apparatus for a portable information device where a plurality of application programs (hereinafter, referred to as intra-terminal applications) are installed, the apparatus being adapted to display a mark indicating the status of version update in a menu screen where a plurality of startup icons for intra-terminal applications are located. The apparatus also monitors the activation status of applications installed in the portable information device, records the frequency of use of the applications based on the activation status, and modifies the mode of displaying the mark based on the frequency of use. In this way, the user of a portable information device is capable of instantly identifying the information on a version update of the application, using the screen.

A general explanation of the portable information device will be given first, followed by a detailed explanation of an application update management function according to the embodiment.

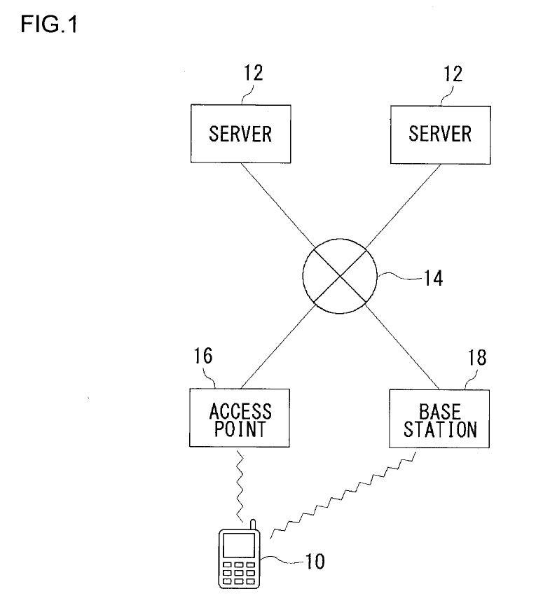

FIG. 1 shows the overall configuration of a network system including a portable information device 10 provided with an application update management function according to the embodiment

The portable information device 10 may be any hardware movable with the user, such as a laptop PC (personal computer), PDA, cellular phone, and car navigation device provided with communication functions. The portable information device 10 is connected by the user's operation to a network 14, such as a LAN and the Internet, via an access point 16 or a base station 18, and is capable of accessing a server 12 specified by a URL and of acquiring desired data.

The server 12 provides the portable information device 10 with data such as text data, image data, audio data, video data, etc. via the network 14. The server may be a service entity on the Internet such as a web server. In that case, the invention may be implemented in various modes including: a mode embodied, for example, by a Common Gateway Interface (CGI) in which the server side takes care of the major processing functions; a mode embodied by, for example, a Java (registered trademark) applet in which the major processing functions are shifted to the client side; and a mode of Application Program Interface (API) type in which the main processing functions (e.g., Java applications) are distributed both to a server and a client.

The portable information device 10 is configured so that it can refer to and edit a file stored in an internal storage or a storage medium by the user's operation, even if the device does not access the network 14.

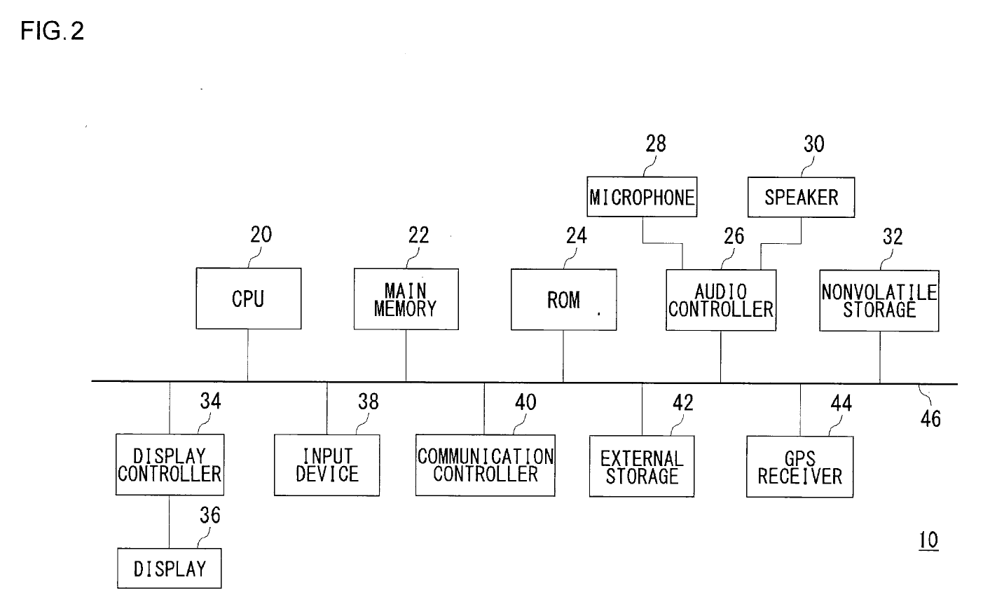

FIG. 2 shows the hardware configuration of the portable information device 10. The portable information device 10 is provided with a CPU 20, a main memory (RAM) 22, a ROM 24, an audio controller 26, a nonvolatile storage 32, a display controller 34, an input device 38, a communication controller 40, an external storage 42, and a GPS receiver 44. These are mutually connected via a bus 46.

The CPU 20 runs an operating system and controls the entire portable information device 10. The CPU 20 also reads into the main memory 22 a program and data from the ROM 24 or the recording medium loaded into the external storage 42, and performs various kinds of processing accordingly. The main memory 22 serves as a temporary storage and a work area which is needed when the CPU 20 executes the program, and as an area which stores various kinds of data required for program execution. The ROM 24 is a read-only storage which stores a computer program and data processed by the CPU 20.

The audio controller 26 is provided in the portable information device such as a cellular phone provided with a telephone function and is connected with a microphone 28 and a loudspeaker 30 for audio input output control.

The nonvolatile storage 32 is a storage capable of retaining the memory content even after power OFF, and may be a hard disk drive or a semiconductor memory such as a flash memory.

The display controller 34 generate a video signal for displaying the data drawn by the CPU in a frame buffer (not shown) on a display 36 provided in the portable information device 10.

The input device 38 is a device for the user to provide directions for operation to the portable information device 10. The input device 38 may be any device suited to the terminal. For example, the device may be: keys; a pointing device like a trackpad; buttons; and a touch panel provided on the surface of the display 36. A mouse may be connected to the portable information device via a universal serial bus (USB) terminal.

The communication controller 40 controls communication of sound and data by various communication schemes. The data communication scheme may be wireless LAN such as IEEE802.1b/g, infrared communication, or data communication such as packet communication. The portable information device 10 may be connected to the network 14 using a cable.

The external storage 42 is a drive device which uses a removable recording medium. The recording medium may be a magnetic disk, an optical disk, a magneto-optical disc, or a semiconductor memory.

The GPS receiver 44 is a device which locates the portable information device based on radio wave from a satellite.

Since the constituting elements described above are all well known, a description of further details will be omitted.

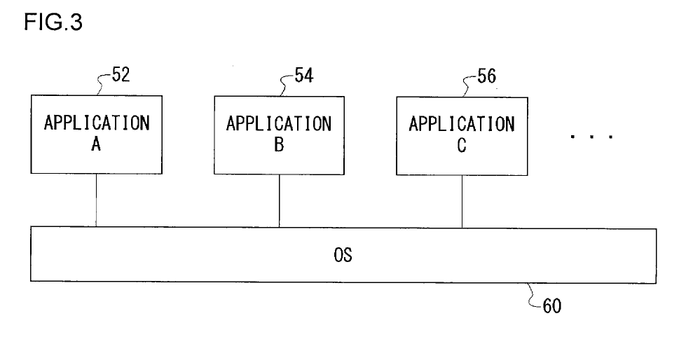

FIG. 3 is a block diagram for explaining a relationship between an application program and a document processing unit in the portable information device 10. A kernel 60 of an operating system can simultaneously execute a plurality of application programs and supports a preemptive multi-task. The application update management function is preferably provided as part of the functions of operating system. By managing the version information of the applications on the OS level, information on the updates of applications can be communication to the user without starting the individual intra-terminal applications 52-56.

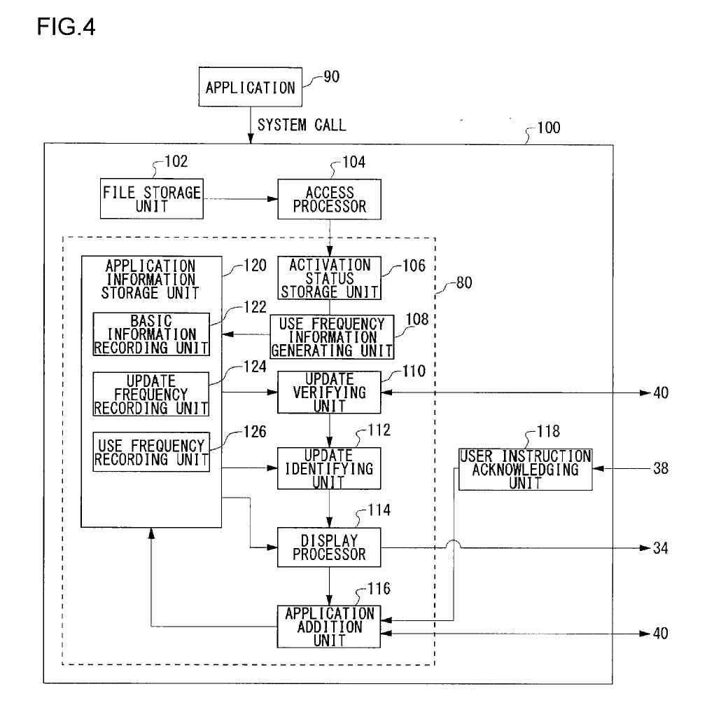

FIG. 4 shows the configuration of those parts of the portable information device 10 related to an application update management device 100 according to the embodiment. The configuration is implemented in hardware by any CPU of a computer, a memory or other LSI's, and in software by a program or the like loaded into the memory. FIG. 3 depicts functional blocks implemented by the cooperation of hardware and software. Therefore, it will be obvious to those skilled in the art that the functional blocks may be implemented in a variety of manners including hardware only, software only, or a combination thereof.

As mentioned above, it is preferable that the application update management device 100 is implemented by a part of an operating system. An operating system has various functions, such as process management, memory management, device management, and GUI. Of those functions implemented by the combination, FIG. 4 illustrates only those which pertain to this embodiment. A portion 80 enclosed with the dashed line in FIG. 4 shows the functional block added to the operating system for realization of this embodiment. Those functions provided in a common operating system are of course provided even if they are not shown in FIG. 4.

A detailed description will now be given of the operation and structure of the blocks.

A file storage unit 102 holds a plurality of files read by various kinds of applications. Files may be acquired via a network or stored in the storages 32 and 42 of the portable information device 10.

When a system call for file access is issued from any of a plurality of application programs 90 executable in the portable information device 10, an access processor 104 selects from the file storage unit 102 the file specified by the system call. The processor then accesses the file designated by the system call. The file access process specified by a system call includes opening and closing, writing, deletion, etc. of a file. As a result of the file access by the access processor 104, a screen showing the execution of the file by the intra-terminal application is displayed on the display 36 of the portable information device 10.

An activation status storage unit 106 stores the state of activation of an intra-terminal application, by referring to a system call, processed by the access processor 104, for file access or file close from the intra-terminal application.

A use frequency information generating unit 108 creates use frequency information for each intra-terminal application by referring to the activation status stored in the activation status storage unit 106. The use frequency information includes the number of times that the intra-terminal application is activated (started), total time, time elapsed since the last use, etc. The number of times that each intra-terminal application is started is known from the frequency of file accesses, which is one of the factors determining the activation status. By determining a period of time required between file access and file close, the total period of time that each intra-terminal application is used is known. By examining the time that the file was closed last time and the current time, the time elapsed since the intra-terminal application was last used is known.

An application information storage unit 120 stores various information related to intra-terminal applications in an associated storage unit. A basic information recording unit 122 records basic information related to intra-terminal applications, including the versions of intra-terminal applications installed in the portable information device 10, IDs assigned to the intra-terminal applications, and the addresses of delivery servers from which the latest versions can be downloaded. Information like version information and IDs are preferably recorded when the intra-terminal application is installed. An update frequency recording unit 124 records the time and date that the version of the intra-terminal application is updated, the frequency of updates, etc. The update frequency recording unit 124 may further record information such as the frequency of communicating information on version updates or the number of days elapsed since the first communication, by, for example, displaying a predetermined mark in a menu screen. A use frequency recording unit 126 records the use frequency information created by the use frequency information generating unit 108.

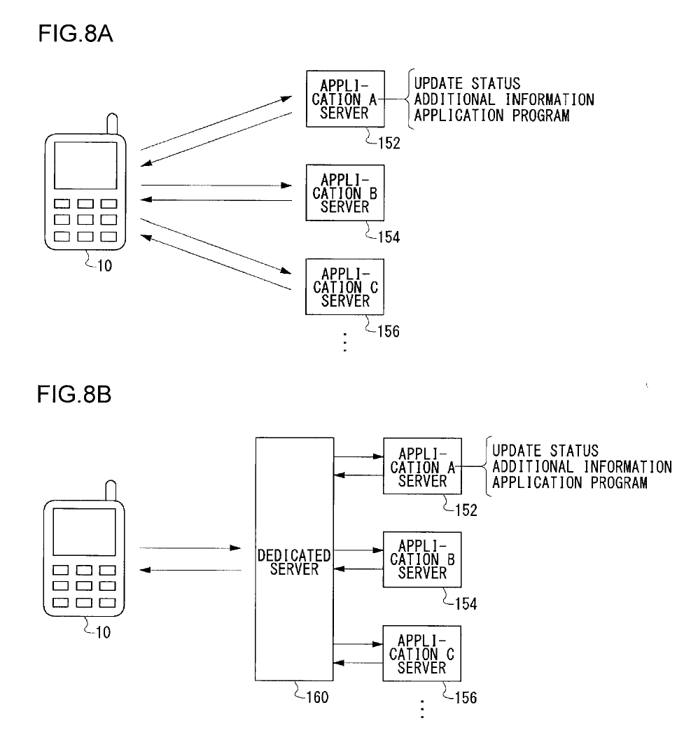

An update verifying unit 110 receives update status data indicating whether there is any version update of at least one of the intra-terminal applications from a delivery server configured to deliver applications. The unit 110 may receive the update status data for applications from a plurality of servers delivering the latest versions of the associated intra-terminal applications. Alternatively, the unit 110 may collectively receive the update status data from a dedicated server for centralized management of the update status of a plurality of intra-terminal applications. This will be described in detail with reference to FIG. 8.

An update identifying unit 112 compares the update status data for the latest version received from the server with the version data for the intra-terminal application stored in the basic information recording unit 122 and identifies an intra-terminal application assigned an older version number.

A display processor 114 produces a menu screen where a plurality of startup icons for a plurality of intra-terminal applications are located, and displays the screen on the display 36 via the display controller 34. Further, the display processor 114 changes the appearance of the startup icon for the intra-terminal application identified by the update identifying unit 112 to indicate that an update to the version is available. The appearance of a startup icon is designated in a table format. The display processor 114 refers to the table to retrieve an associated image from a predetermined memory area, and displays the image accordingly. For example, the display processor 114 changes the appearance of the startup icon by adding a mark indicating that an update to the version is available.

The display mode of “menu screen” produced by the display processor 114 is non-limiting so long as startup icons for a plurality of application programs are displayed and one of the icons can be selected. When the terminal provided with an application update management function is a cell phone, the menu screen may be a standby screen or a background screen where some of the startup icons are located. The main screen of a portal site viewed by a browser provided in the terminal may be the menu screen, if the main screen shows icons from which applications can be started.

The display processor 114 may use the use frequency information for the intra-terminal application recorded in the use frequency recording unit 126. For example, the display processor 114 may change the appearance of the startup icon for an intra-terminal application depending on the use frequency. Alternatively, the display processor 114 may change the appearance of the startup icon for those intra-terminal applications which are identified by the update identifying unit 112 and which are used with a frequency equal to or greater than a predetermined value.

The display processor 114 may use the update frequency information stored in the update frequency recording unit 124. For example, when there is a non-updated application which has not been updated for a long period of time despite the fact that the user is notified of the update to the version, the display processor 114 may change the appearance of the startup icon for the non-updated application program to an appearance different from the appearance indicating that there is an update to the version.

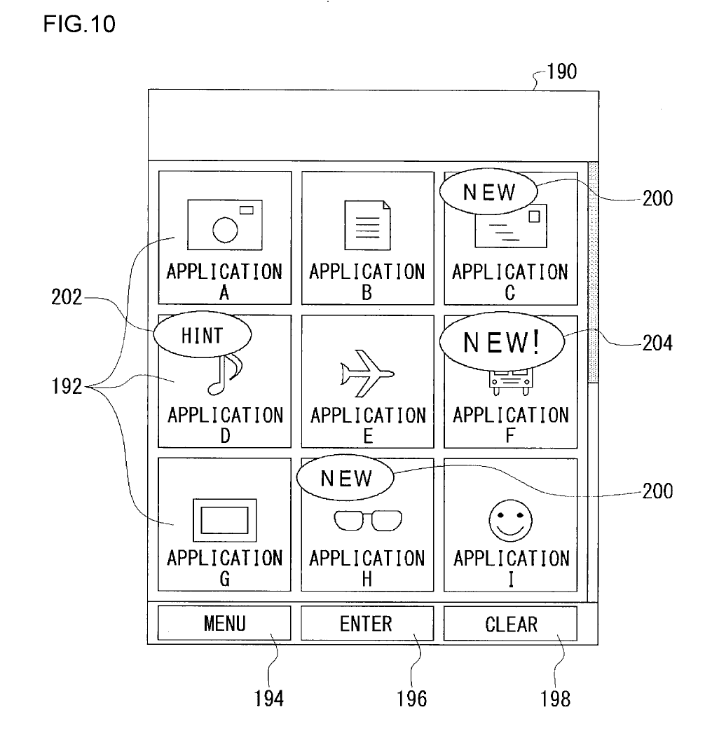

Specific exemplary appearances of startup icons will be described later with reference to FIGS. 10 through 13.

A user instruction acknowledging unit 118 acknowledges an instruction for button operation, etc. initiated by the user while the menu screen comprising a plurality of startup icons is being displayed. More specifically, the display processor 114 displays an option for installing an updated application, overlaying the option on the menu screen comprising the startup icon with the changed appearance. When the option is selected by the user, the user instruction acknowledging unit 118 notifies an application addition unit 116 accordingly.

When the user requests the installation of the latest version of the intra-terminal application, the application addition unit 116 refers to the IP address or the URL of the delivery server recorded in the basic information recording unit 122 and connects to the delivery server, so as to download the latest version of the intra-terminal application. The unit 116 then installs the application in the portable information device 10. When the installation is completed, the application addition unit 116 rewrites the version-related information in the basic information recording unit 122 and the information in the update frequency recording unit 124 related to the frequency of updates.

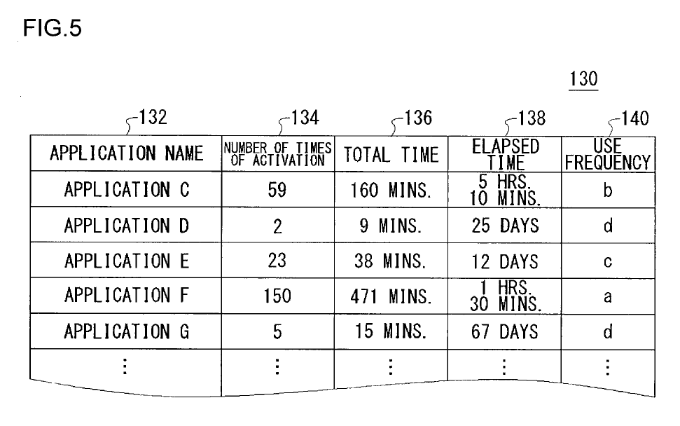

FIG. 5 shows a table 130 including exemplary use frequency information generated by the use frequency information generating unit 108 based on the record of activation status.

An application name column 132 lists the names of intra-terminal applications. FIG. 5 lists applications C through G. An activation frequency column 134 lists the number of times that the intra-terminal application is started within a predetermined period of time. A total time column 136 lists total time for which the intra-terminal application remains activated within the predetermined period of time. An elapsed time column 138 lists a time elapsed since the intra-terminal application was last used until the tally is made by the use frequency information generating unit 108. The “predetermined period of time” is a time elapsed until now since the portable information device 10 began to be used. The predetermined period of time could be a time elapsed since the portable information device 10 was initialized or a time elapsed since the user deleted the history of activation status.

The use frequency information generating unit 108 may generate scores of use frequency based on the number of times started n, total time t, and elapsed time p. For example, scores a-e are assigned in the descending order of use frequency. The score may be computed based on a comparison between a threshold and the result obtained by substituting the number of times started n, total time t, and elapsed time p into a predetermined expression. Alternatively, the score may be computed by comparing the number of times started n, total time t, and elapsed time p with respective thresholds and selecting the maximum of the scores.

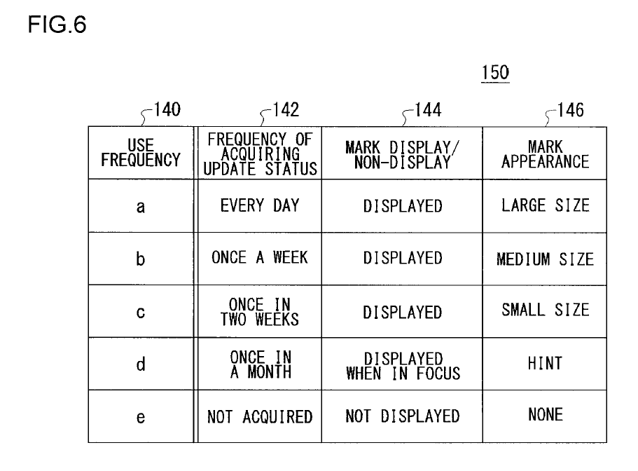

FIG. 6 shows a table that maps the score of use frequency, the frequency of acquiring update status data, and the change in the appearance of a startup icon to each other. A use frequency column 140 lists scores of use frequency. An acquisition frequency column 142 lists the frequency of acquiring update status data by the update verifying unit 110. For example, frequencies such as “every day” or “once a week” are associated with use frequency scores. The update verifying unit 110 acquires the use frequency scores of the intra-terminal applications from the use frequency recording unit 126 and determines how frequently the update status data should be acquired, by referring to the table 150.

A mark display/non-display column 144 indicates whether a mark, indicating that an update to the version is available, should be attached to the startup icon when an update to the version of the intra-terminal application is available. The display processor 114 acquires the use frequency score of the intra-terminal applications from the use frequency recording unit 126 and determines whether to attach a mark by referring to the table 150. When “Display” is indicated in the table, a mark remains attached to the startup icon displayed in the menu screen. When “Displayed when in focus” is indicated in the table, a mark is attached to the startup icon only when the startup icon is in focus in the menu screen. When “Not displayed” is indicated, no marks are attached to the startup icon.

A mark appearance column 146 designates the appearance of a mark attached to the startup icon. The table 150 designates large, medium, and small sizes of a mark for the use frequency scores a-c of the intra-terminal application. The table indicates that a hint mark is displayed for the use frequency score d. The display processor 114 attaches images of marks as designated to startup icons.

The mark appearance column 146 may designate the color or the mode of display of the mark attached to the startup icon. For example, the higher the use frequency, the more noticeable the color. Alternatively, the lower the use frequency, the higher the transparency of the mark. Still alternatively, the table may indicate that the mark flashes or appears vibrated when the use frequency is high. Yet alternatively, the type of a mark may be designated in the mark appearance column 146. For example, the table may indicate that, when the use frequency of the intra-terminal application is comparatively high, the mark attached to the startup icon indicates that there is an update to the version, and, when the use frequency is comparatively low, a mark prompting the use of the intra-terminal application is attached to the startup icon.

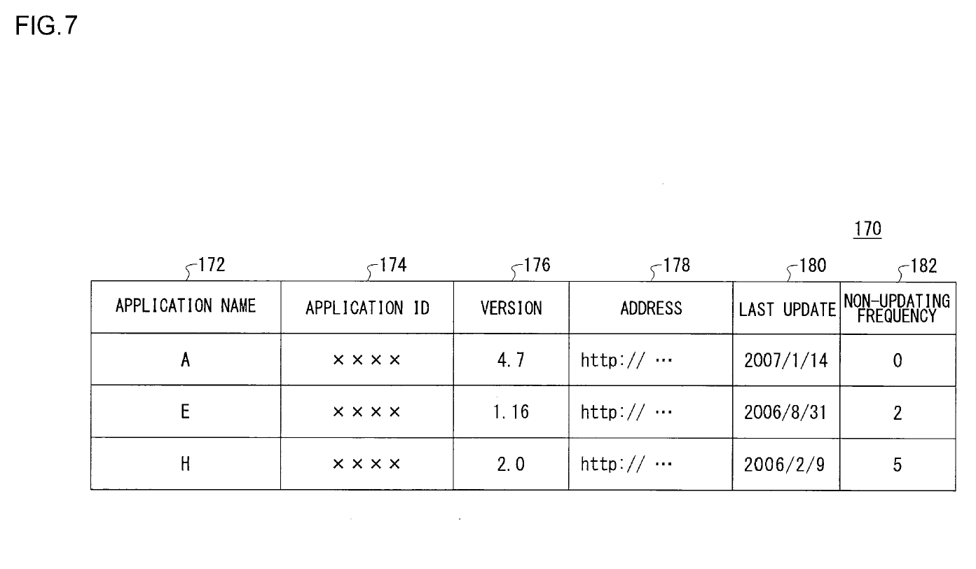

FIG. 7 shows a table 170 including exemplary information stored in the basic information recording unit 122 and the update frequency recording unit 124. An application name column 172 lists the names of intra-terminal applications. FIG. 7 lists applications A, E, and H. An application ID column 174 lists the IDs assigned to the intra-terminal applications. A version column 176 lists the versions of the intra-terminal applications installed in the portable information device 10 at that point of time. An address column 178 indicates the location of storage on the network capable of delivering the latest version of the intra-terminal application. The location of storage is a network address or a URL designating the delivery server. The application addition unit 116 accesses the delivery server in accordance with the information and acquires the latest version of the program.

A latest update column 180 indicates the time and date that the intra-terminal application is last updated. A non-updating frequency 182 indicates the number of times that the application is not updated in response to the notification of version update. For example, given that the non-updating frequency of application E is 2, it shows that the current version 1.16 is two versions older than the latest version.

FIGS. 8A and 8B schematically show how update status data is acquired. In this embodiment, the portable information device 10 manages the version information of the intra-terminal applications. Therefore, as shown in FIG. 8A, the update verifying unit 110 acquires the address of the delivery server defined for the intra-terminal application installed, from the basic information recording unit 122. The unit 110 requests the delivery server to transmit the version update status at an updating frequency defined for the use frequency. The delivery servers 152-156 corresponding to the intra-terminal applications store the update status data indicating the status of update to the application versions, the latest versions of the application programs, and other additional information. The servers 152-156 transmit the update status data in reply to a request from the update verifying unit 110. When receiving a request for transmission of the latest version of the application from the application addition unit 116 of the portable information device 10, the servers transmit the corresponding application.

FIG. 8B shows an alternative embodiment in which a dedicated server 160 intervenes between the portable information device 10 and the delivery servers 152-156 for the respective intra-terminal applications. In this embodiment, the dedicated server 160 acquires the update status data for the intra-terminal applications from the delivery servers 152-156 at a predetermined frequency. The server 160 stores the data in association with the IDs of the intra-terminal applications. The update verifying unit 110 of the portable information device 10 acquires the ID of the intra-terminal application from the basic information recording unit 122 and transmits the ID to the dedicated server 160. The dedicated server 160 selects the update status data related to the received ID and transmits the data to the update verifying unit 110. In the embodiment of FIG. 8B, the update status data can be transmitted and received between the dedicated server 160 and the delivery servers 152-156. Therefore, the frequency of acquiring the update status data can be increased. Since the update verifying unit 110 is capable of acquiring the update status data for all intra-terminal applications in a single session of communication with the dedicated server 160, the volume of communication is advantageously reduced.

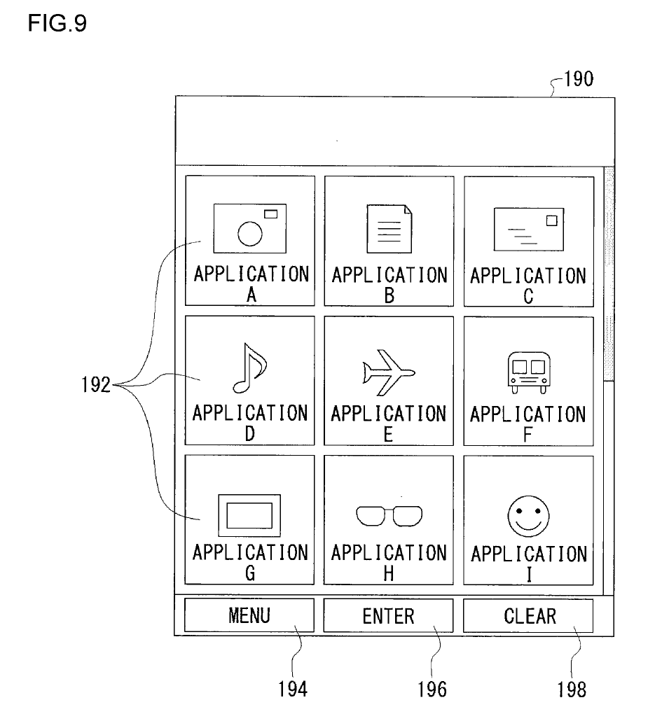

FIG. 9 shows an exemplary menu screen displayed on a display screen 190 of the portable information device 10. Startup icons 192 representing application A through application I, which are intra-terminal applications, are displayed in the menu screen. A menu key 194, an enter key 196, and a clear key 198 are associated with respective buttons of the portable information device 10. When the menu key 194 is operated, a menu including a plurality of options available for execution at that point of time is displayed. The enter key 196 is operated when the user selects a startup icon or an option. The clear key 198 is used to go one step backward. When the user uses an input device such as a directional key (not shown) to shift the focus to one of the startup icons and operates the enter key 196, the corresponding intra-terminal application is started.

FIG. 10 shows how a mark indicating an update to the version is attached to a startup icon. It is assumed in this case that the update verifying unit 110 determines that an update to the version occurs in applications C, D, F, and H. The display processor 114 displays a “NEW” mark 200, attaching the mark to the startup icons for applications C and H. Since the use frequency score for application F is “a”, a large-sized “NEW” mark 204 is displayed and attached to the startup icon. Since the use frequency score for application D is “d”, a hint mark 202 is displayed and attached to the startup icon instead of a “NEW” mark.

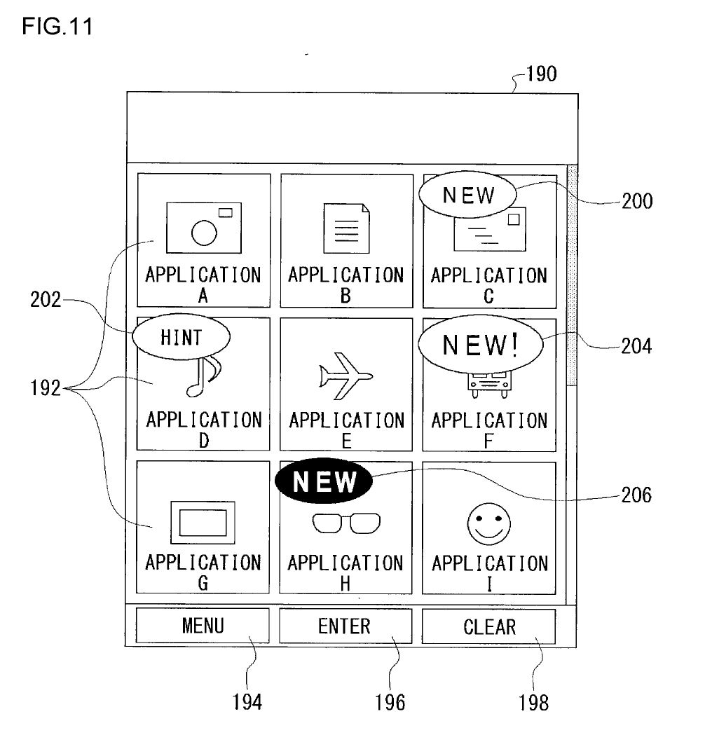

FIG. 11 shows how another mark indicating an update to the version is attached to a startup icon. The display processor 114 acquires the last update time and date 180 from the update frequency recording unit 124. When the display processor 114 determines that a predetermined period of time (e.g., half year) elapses since the last update, the display processor 114 displays a mark having a different appearance. Alternatively, the display processor 114 may display a mark having a different appearance when the display processor 114 determines that the non-updating frequency 182 reaches a predetermined frequency (e.g., 5 times). In the illustrated example, the display processor 114 displays a reversed “NEW” mark 206, attaching the mark to the icon, since a long period of time elapses since the last update to the version of application H. In this way, information other than the fact that an update to the version is available can be conveyed to the user.

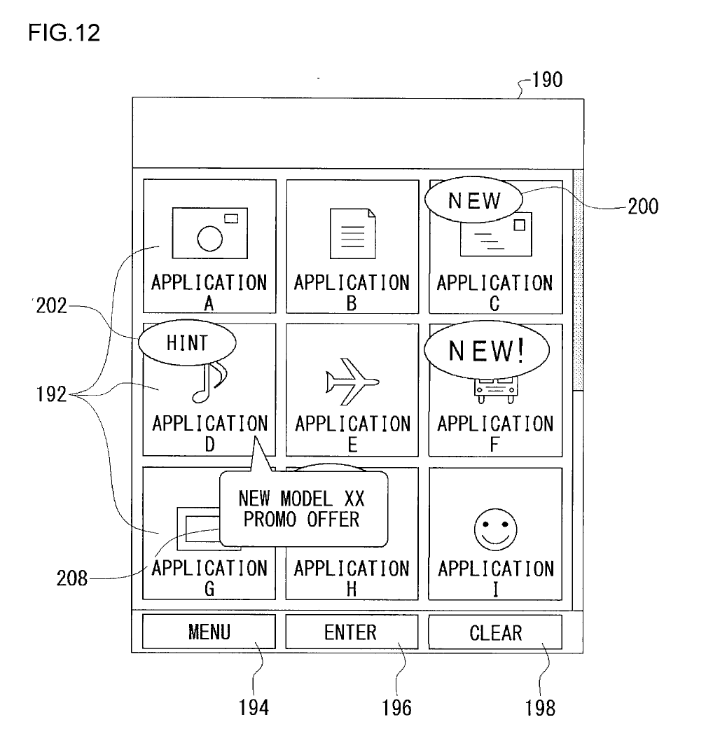

FIG. 12 shows how information other than that of version update is acquired from the delivery server and displayed. As illustrated, a pop-up display 208 is attached to the startup icon for application D in addition to the hint mark 202. The additional information is transmitted from the delivery server to the portable information device 10. Examples of additional information include information for recommending the use of the application, information related to the method of using the application, and information on related software. The use frequency score of the intra-terminal application may be referred to so that the additional information is displayed only when the score is equal to or higher than a predetermined score, or when the score is equal to or lower than a predetermined score. The additional information transmitted may include the date when the support for the intra-terminal application is terminated, virus information, or urgency of the update. In this case, the display processor 114 may display a support termination mark, virus warning mark, or urgent update recommendation mark stored in a predetermined memory area, attaching the mark to the startup icon.

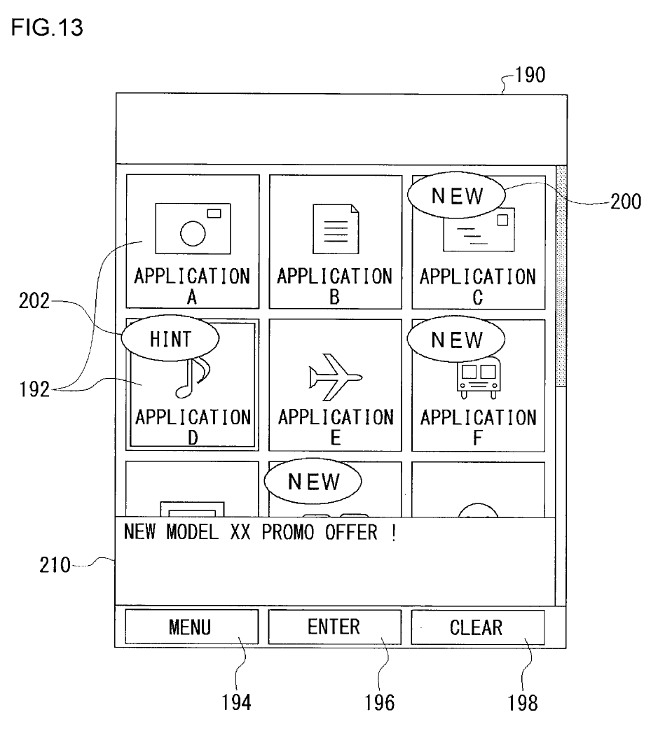

FIG. 13 shows an alternative mode of displaying additional information. FIG. 13 shows that a window 210 for displaying additional information is set up toward the bottom of the screen 190 and displayed overlaid on the menu screen. The additional information related to the intra-terminal application the startup icon of which is brought into focus is displayed in the window 210.

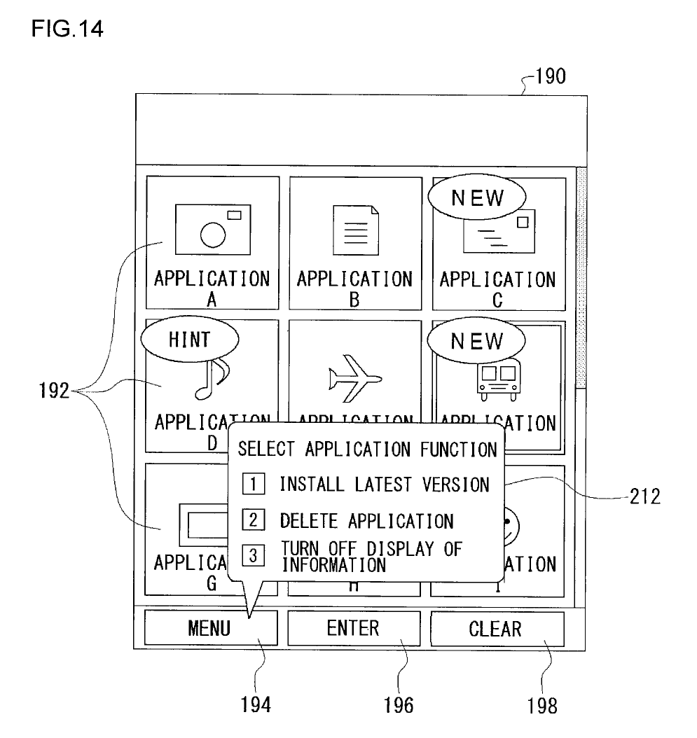

FIG. 14 shows how the latest version of the intra-terminal application, the startup icon of which has a NEW mark attached thereto, is installed. When the menu key 194 is operated while the startup icon having the NEW mark attached thereto is in focus, a pop-up menu 212 including a plurality of options is displayed. In this example, options “Install latest version”, “Delete application”, and “Turn off display of information” are indicated. When “Install latest version” is selected, the application addition unit 116 accesses the delivery server for the corresponding intra-terminal application and downloads the latest version of the program. Subsequently, the unit 116 installs the program. Thus, it is ensured that the application for which an update is made known by attaching a NEW mark is updated without requiring any complex operations. A simple operation suffices to update to the latest version.

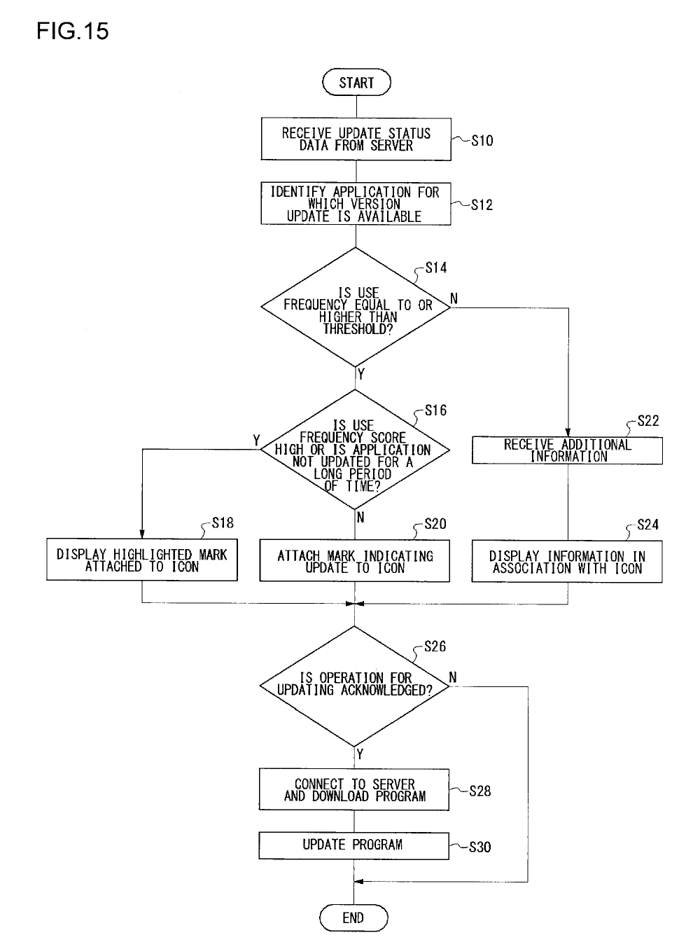

FIG. 15 is a flowchart showing an exemplary process, according to the embodiment, of managing an update to the application.

The update verifying unit 110 receives the update status data from the delivery server according to a predetermined timing schedule (S10). The update identifying unit 112 identifies the intra-terminal application for which an update to the version is available, by comparing the update status data with the version data in the basic information recording unit 122 (S12). The display processor 114 acquires from the use frequency recording unit 126 the use frequency scores of the intra-terminal applications for which an update to the version is available and determines whether the use frequency score is equal to or higher than a threshold for each application (S14). When the score is lower than the threshold (N in S14), the display processor 114 receives the additional information for the application from the server (S22). The display processor 114 displays a mark corresponding to the additional information in the menu screen, attaching the mark to the startup icon, or displays the additional information in association with the startup icon (S24).

When the use frequency score is equal to or higher than the threshold (Y in S14), the display processor 114 determines whether the use frequency score is the maximum score or the version of the application has not been updated for a predetermined period of time or longer (S16). If either of the answers is in the affirmative (Y in S16), the display processor 114 displays a highlighted mark corresponding to the event in the menu screen, attaching the mark to the startup icon (S18). If neither of the answer is in the affirmative (N in S16), the display processor 114 displays a mark indicating that an update to the version is available in the menu screen, attaching the mark to the startup icon (S20).

The user instruction acknowledging unit 118 acknowledges an operation for updating the application indicated by the user to be be updated (S26). When the operation is completed (Y in S26), the application addition unit 116 connects to the delivery server of the corresponding application and downloads the latest version of the program (S28). The application addition unit 116 installs the program in the portable information device 10 (S30) and rewrites the version-related information in the basic information recording unit 122 and the update frequency recording unit 124.

As described above, according to the embodiment, the user can instantly identify those of the intra-terminal applications for which version update is available, by displaying a mark indicating that an update to the version is available in the menu screen, attaching the mark to the startup icon. It is up to the user whether to actually update the version of the intra-terminal application.

This embodiment provides the OS with the function of managing updates to the versions of intra-terminal applications, instead of allowing the applications to perform the management after startup. In this way, the update status is acquired from the server before starting the application so that the user is promptly notified of whether an update to the version is available.

A version update mark is displayed only for those of intra-terminal applications that are used comparatively frequently. Updates to the versions of intra-terminal applications that the user does not usually use are not displayed in an intrusive manner

By changing the appearance of a mark attached to the startup icon depending on the use frequency of intra-terminal applications or frequency of updates to the versions, various additional information other than the information on an update to the version can be conveyed to the user.

It is ensured that, by operating the menu key while a marked startup icon is being displayed, the option to start installing the corresponding intra-terminal application is displayed. Therefore, the version of the intra-terminal application can be updated without delay from the menu screen.

Described above is an explanation based on an exemplary embodiment. The embodiment is intended to be illustrative only and it will be obvious to those skilled in the art that various modifications to constituting elements and processes could be developed and that such modifications are also within the scope of the present invention.

The update verifying unit 110 may receive, as update status data, information related to the importance of the update to the version. In this case, the display processor 114 changes the appearance of the startup icon for the application program for which an update is available, depending on the importance of the update. If the program should be urgently updated for reasons of, for example, security, the icon may look more noticeable by, for example, flashing the mark. This allows the user to instantly understand whether the update is important or is a minor change in the menu screen.

The display processor 114 according to the embodiment is described as changing the appearance of the startup icon only for those intra-terminal applications that are frequently used. Alternatively, the update verifying unit 110 may refer to the use frequency information in the use frequency recording unit 126 before accessing the server and receive the corresponding update status data only for those intra-terminal applications with a comparatively high use frequency score. The intra-terminal applications are selected by, for example, comparing the use frequency score with a predetermined value or selecting five of the intra-terminal applications with the highest scores. Limiting the update status data received as described above helps reduce the packet charge incurred for communication with the server. The feature will be particularly useful if the terminal is a cellular phone.

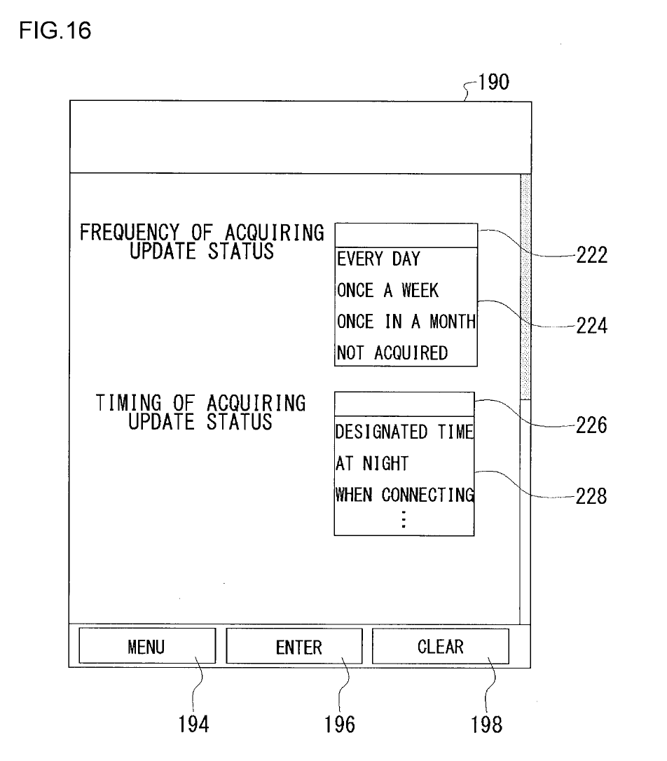

In the embodiment, the frequency of acquiring the update status data from the delivery server is described as being changed in accordance with the use frequency of the intra-terminal application. Alternatively, the timing or frequency of acquiring the update status data may be set by the user. FIG. 16 shows an exemplary screen for setting. As shown in the figure, fields 222 and 226 for designating “frequency of acquiring update status” and “timing of acquiring update status”, respectively, are displayed. Pull-down menus 224 and 228 each including a plurality of options are displayed below. For example, the data charge will be reduced by reducing the frequency of acquiring the update status data or setting an inexpensive time zone for acquisition.

In the embodiment, the mark indicating that an update to the version is available is described as being attached to the startup icon. Instead, the startup icon may change its appearance itself. For example, the color of a startup icon may change from normal, or the icon may look semitransparent or flash. Alternatively, the icon may be rotated or vibrated. The same mode of control as used for the mark may be applied to the display mode of the startup icon. In other words, the appearance of a startup icon may be changed in a variety of combinations, in accordance with the use frequency or update frequency of the intra-terminal application, or in accordance with the importance of the update to the application.

In the described embodiment, the version information on the intra-terminal application is described as being managed by the portable information device. In other words, the version information on the intra-terminal application is stored in the portable information device. Instead, the version information may be managed by the server. In this case, the version information on the intra-terminal application installed in the portable information device 10 is transmitted from the portable information device 10 to the dedicated server 160 in the initial communication. Thereafter, the information is managed by the dedicated server 160. The dedicated server 160 receives the update status from the delivery servers for the respective applications at a predetermined timing schedule and stores the status in association with the application ID. The dedicated server 160 compares the version data for the intra-terminal application stored in the server with the update status. When an intra-terminal application that is not the latest version is found, the server transmits the update status data to the update verifying unit 110.

By allowing the dedicated server to manage the version information, the number of times that the portable information device 10 and the dedicated server 160 communicate can be reduced since the version information may be transmitted only when the dedicated server identifies an update to the application.

Alternatively, the portable information device and the dedicated server may share the task of managing the version information on the intra-terminal applications. For example, the dedicate server may manage the information on those applications that are pre-installed in the portable information device 10, and the portable electronic device may manage the information on those applications that are added later by the user. In this configuration, the update status data for the application managed by the dedicated servers is transmitted to the portable information device 10 when the dedicated server identifies an update to the version. The update status data for the application managed by the portable information device 10 is transmitted from the dedicated server in response to an inquiry from the update verifying unit 110. This makes it possible to indicate the version update information in the menu screen without fail, including the information on the intra-terminal applications which are added later by the user and the update status of which is hard for the dedicated server to keep track of.

Hash values may be used as version data for the intra-terminal applications. For example, the hash value of the intra-terminal application file of the portable information device 10 may be recorded in the basic information recording unit 122 as the version data. Alternatively, the dedicated server may record the hash value of the latest version of an application file as the update status data. The hash values are compared in the portable information device or in the server for each application. When the hash values do not match, the update identifying unit 112 may determine that an update to the version of the application is available.

In this embodiment, the information presenting apparatus according to the present invention is described as being implemented in a portable information device such as a cell phone, a PDA, a vehicle navigation device, etc. provided with data communication functions. The inventive apparatus may of course be implemented in desktop hardware such as a desktop PC.

### INDUSTRIAL APPLICABILITY

According to the invention, those of the application programs installed in a terminal that are updatable can be recognized easily.

1. A terminal provided with an application update management function, comprising:
a version storage unit operative to store version data for a plurality of application programs stored in the terminal;
an update verifying unit operative to receive, from a server managing the versions, update status data indicating whether an update to the version of at least one of the plurality of application programs is available;
an update identifying unit operative to refer to the update status data and identify an application program assigned an older version number in comparison with the updated version; and
a display processor operative to display a menu screen where a plurality of startup icons for the plurality of application programs are located, and to change the appearance of the startup icon for the application program identified by the update identifying unit to indicate that an update to the version is available.

2. The terminal provided with an application update management function according to claim 1, further comprising:
a use frequency information recording unit operative to record use frequency of the plurality of application programs in the terminal, wherein
the display processor changes the appearance of the startup icon for the application program identified by the update identifying unit, depending on the use frequency.

3. The terminal provided with an application update management function according to claim 1, further comprising:
a use frequency information recording unit operative to record use frequency of the plurality of application programs in the terminal, wherein
the display processor changes the appearance of the startup icon for the application program which is identified by the update identifying unit and which is used comparatively frequently in the terminal.

4. The terminal provided with an application update management function according to claim 2, wherein
the display processor changes the appearance of the startup icon by adding a mark indicating that an update to the version is available.

5. The terminal provided with an application update management function according to claim 1, wherein
when there is a non-updated application which has not been updated for a comparatively long period of time despite the fact that the user is notified of the update to the version, the display processor changes the appearance of the startup icon for the non-updated application program to an appearance different from the appearance indicating that there is an update to the version.

6. The terminal provided with an application update management function according to claim 2, wherein
the update verifying unit receives the update status data only for the application program used comparatively frequently in the terminal.

7. The terminal provided with an application update management function according to claim 1, wherein
the update verifying unit further receives information related to the importance of the update to the version as update status data, and
the display processor changes the appearance of the startup icon for the application program for which an update is available, depending on the importance of the update.

8. A computer-readable storage medium having computer readable instructions for an application update management program to be executed on a terminal, the instructions comprising:
storing version data for a plurality of application programs stored in the terminal;
receiving, from a server managing the versions, update status data indicating whether an update to the version of at least one of the plurality of application programs is available;
identifying an application program for which an update is available, based on the update status data; and
displaying a menu screen where a plurality of startup icons for the plurality of application programs are located, and changing the appearance of the startup icon for the application program for which an update is available to indicate that an update to the version is available.

9. A server-client application update management system for managing the update of applications installed in a terminal, comprising:
an update management server; and
a terminal, wherein
the update management server comprises:
a version storage unit operative to store version data for a plurality of application programs stored in the terminal;
an update verifying unit operative to receive, from a delivery server configured to deliver an application program, update status data indicating whether an update to the version of at least one of the plurality of application programs is available; and
an update identifying unit operative to refer to the update status data and identify an application program assigned an older version number in comparison with the updated version, and to transmit identification information on the application program thus identified to the terminal;
the terminal comprises:
a receiver unit operative to receive identification information on an application program from the update management server; and
a display processor operative to display a menu screen where a plurality of startup icons for the plurality of application programs are located, and to change the appearance of the startup icon for the application program corresponding to the identification information to indicate that an update to the version is available.

10. The computer-readable storage medium according to claim 8, instructions further comprising:
recording use frequency of the plurality of application programs in the terminal, and
wherein the instructions for displaying the menu screen changes the appearance of the startup icon for the application program identified, depending on the use frequency.

11. The computer-readable storage medium according to claim 10, wherein
the instructions for displaying the menu screen changes the appearance of the startup icon by adding a mark indicating that an update to the version is available.

12. The computer-readable storage medium according to claim 10, wherein
the instructions for receiving update status data receives the update status data only for the application program used comparatively frequently in the terminal.

13. The computer-readable storage medium according to claim 8, instructions further comprising:
recording use frequency of the plurality of application programs in the terminal,
wherein the instructions for displaying the menu screen changes the appearance of the startup icon for the application program which is identified and which is used comparatively frequently in the terminal.

14. The computer-readable storage medium according to claim 8, wherein
when there is a non-updated application which has not been updated for a comparatively long period of time despite the fact that the user is notified of the update to the version, the instructions for displaying the menu screen changes the appearance of the startup icon for the non-updated application program to an appearance different from the appearance indicating that there is an update to the version.

15. The computer-readable storage medium according to claim 8, wherein
the instructions for receiving update status data further receives information related to the importance of the update to the version as update status data, and
the instructions for displaying the menu screen changes the appearance of the startup icon for the application program for which an update is available, depending on the importance of the update.

16. The application update management system according to claim 9, wherein the terminal further comprises a use frequency information recording unit operative to record use frequency of the plurality of application programs in the terminal,
the display processor changes the appearance of the startup icon for the application program identified by the update identifying unit, depending on the use frequency.

17. The application update management system according to claim 16, wherein
the display processor changes the appearance of the startup icon by adding a mark indicating that an update to the version is available.

18. The application update management system according to claim 16, wherein
the update verifying unit receives, from the terminal, the update status data only for the application program used comparatively frequently in the terminal.

19. The application update management system according to claim 9, wherein the terminal further comprises a use frequency information recording unit operative to record use frequency of the plurality of application programs in the terminal, wherein
the display processor changes the appearance of the startup icon for the application program which is identified by the update identifying unit and which is used comparatively frequently in the terminal.

20. The application update management system according to claim 9, wherein
when there is a non-updated application which has not been updated for a comparatively long period of time despite the fact that the user is notified of the update to the version, the display processor changes the appearance of the startup icon for the non-updated application program to an appearance different from the appearance indicating that there is an update to the version.

21. The application update management system according to claim 9, wherein
the update verifying unit further receives, from the delivery server, the information related to the importance of the update to the version as update status data, and
the display processor changes the appearance of the startup icon for the application program for which an update is available, depending on the importance of the update.
